(19) United States
(12) Patent Application Publication
(10) Pub. No.: US 2012/0112386 A1
(43) Pub. Date: May 10, 2012

(54) METHOD FOR PRODUCING A SHAPED OBJECT OF A COMPOSITE MATERIAL, A SHAPED OBJECT PRODUCED ACCORDING TO THIS METHOD

(76) Inventor: Ludo Debergh, Mortroux (BE)

(21) Appl. No.: 13/383,854

(22) PCT Filed: Jul. 14, 2010
(86) PCT No.: PCT/IB2010/053218

§ 371 Date: Jan. 13, 2012

(30) Foreign Application Priority Data
Jul. 15, 2009 (BE) 2009/0430

(51) Int. Cl. B29C 43/02; C08L 75/04

(52) U.S. Cl. 264/319; 524/871; 524/500

(57) ABSTRACT

A method for manufacturing a shaped object from a composite material which includes thermoset particles as filler material, fibers as reinforcement material and polyurethane as binder. The method includes the steps of: a) providing a dry mixture of fiber material and thermoset particles with a predefined moisture content; b) the addition and uniform distribution of polyol and isocyanate to the dry mixture; c) curing the mixture in a mould at 15-60° C. under a pressure of at least 50 bar. A shaped object produced with this method.

### FIELD OF THE INVENTION

The invention relates to a method for manufacturing an object from a composite material, and to a shaped object produced in this way.

### BACKGROUND OF THE INVENTION

Various methods for manufacturing composite materials are known. Often a filler material is thereby used to obtain a certain volume, to which fibers are added for increasing the strength, and to which a binder is added for keeping everything together.

EP0442435 describes a method for recycling waste or used objects made from cured (“cross-linked”) plastic, particularly polyurethane, which comprises the steps of: a) reducing the size of leftovers from waste products composed of cross-linked synthetic resin, in particular polyurethane or polyurea, into flakes or granules with a size <15 mm, in particular <=5 mm; b) the material reduced in size is processed in a device using thermo-mechanical energy, for example a kneader for 5 to 30 minutes at a device temperature of 130-180° C., whereby a mechanical-thermal decomposition takes place without mass loss; c) in a mixing device is added to this mass a polyfunctional isocyanate for the renewal of the cross-linking, whereby the mass has a temperature ≦80° C. and the mixing device has a temperature ≦30° C.; d) the reaction mixture is cooled within 10 minutes; e) the mixture is heated for 5 to 20 minutes in a mould to a temperature of 130° C.-170° C. at a pressure of at least 100 bar and is thereby again crosslinked.

A disadvantage of this method and the resulting product is that the product has only moderate mechanical properties.

### SUMMARY OF THE INVENTION

It is an object of the invention to provide a method for manufacturing an object from a composite material which comprises thermoset particles, with improved mechanical properties (e.g. a higher flexural strength).

This object is achieved by a method having the characteristics of the first claim. Thereto the method according to the invention comprises the following steps:

a) providing a dry homogeneous mixture comprising fiber material with an average length of 2-40 mm and a granulate of thermoset particles with an average particle size of 2-15 mm, whereby the volume percent of the fiber material is 10-80% of the dry homogeneous mixture, and whereby the dry homogeneous mixture has a moisture content which is in equilibrium with air having a dew point of at most 25° C.;

b) adding at least one polyol and at least one isocyanate to the dry homogenous mixture for forming a viscous compound mixture, whereby the weight percent of the at least one polyol and the at least one isocyanate together is 4.0-25.0% of the dry homogeneous mixture, and mixing the viscous compound mixture, thereby forming a viscous homogeneous mixture;

c) forming a shaped object by curing the viscous homogeneous mixture in a mould at a temperature of 15-60° C. under a pressure of at least 50 bar, whereby the pressure is maintained for at least 1 minute.

In this document, by “particle diameter” or “grain size” or “particle size” of a fragment or a particle is meant the largest linear distance between two points of that particle. By “average” is meant the mathematical average over a group of particles.

In this document, by “length of the fiber material” or “fiber length” is meant the largest linear distance between two points of a fragment of a fibrous material, even if the fragment does not have a pronounced elongated shape. By “average” is meant the mathematical average over a group of fragments.

In contrast to the method described in EP0442435 where the cohesion of the particles of the mixture is achieved by cross-linking by means of a poly-isocyanate, and whereby dust and fibers need to be removed because they disturb the cross-linkage (as described in EP0442435), the inventor has surprisingly found that it is possible to add fibers (e.g. glass fibers or carbon fibers) to such a granulate whereby the mechanical properties (such as flexural strength) of the shaped object are improved. According to the invention therefor polyol and isocyanate are added to the dry mixture, which will react together to form polyurethane which serves as a binder for both the granules and for the fibers. By mixing the viscous mixture such that the polyol and the isocyanate are substantially uniformly distributed over the dry homogeneous mixture, this binder (polyurethane) will spread between and around all particles. By compressing this viscous homogeneous mixture before the reaction of the polyol and isocyanate takes place, the polyol and the isocyanate will be pressed in the pores of the particles, and only then react, so that a very strong mechanical adhesion is achieved between the filler material (granules) and the reinforcing material (fibers) and the binder (polyurethane). By shaping in a mould objects having widely different shapes may be produced.

Tests have shown that the resulting object has good mechanical properties (e.g. a drain cover having a flexural strength which meets the load class A and/or B and/or C of standard NBN EN 124) which are comparable to those of existing cast iron objects of the same size, so that the method according to the invention may be used for manufacturing a wide range of objects for which until now usually only concrete or cast iron were used, particularly in the construction industry.

A further advantage of the method according to the present invention is that it allows a large number of non-thermoplastic materials as well as reject or used fiber materials to be recycled, so that these materials no longer have to be incinerated or landfilled, which is beneficial for the environment, and whereby the cost of the objects to be shaped may be drastically reduced. A further advantage of the shaped object according to the invention as compared to a similar object in concrete or steel or cast iron is its lower weight. Another advantage is that the shaped object is highly impact and temperature resistant (over a temperature range of −40° C. to +70° C.). Another advantage of the shaped object according to the invention is that it has a less slippery surface, which is especially advantageous during winter time, which makes such objects especially suitable as paving tiles or the like. Another advantage compared to steel or cast iron is that the composite material of the shaped object according to the invention does not rust. Another interesting advantage thereby is that steel has become particularly scarce and expensive in recent years, so that the price of scrap metal has increased significantly, and because of that also the number of thefts of metal objects located on or along public roads (e.g. sewer gratings, drain covers and the like). This is not only very dangerous for pedestrians or vehicles, but also costs the authorities a lot of money. When the object according to the invention is as much as possible made from recycled material, not only the cost of the shaped objects is very low, but theft is also avoided, since there is no (paying) market for stolen shaped objects from such recycled material.

The inventor has found that the above method does not work well when thermoplastic particles (such as e.g. PVC or PE or PP) or thermoplastic fiber materials are used, because it does not adhere well to polyurethane.

In an embodiment of the method according to the invention, providing the dry homogeneous mixture comprises the following steps: —providing a fiber material with an average length of 2-40 mm, and drying of the fiber material until the fiber material has a moisture content in equilibrium with air having a dew point of at most 25° C., thereby forming a dried fiber material; —providing a granulate of thermoset particles with an average particle size of 2-15 mm, and drying of the granulate until the granulate has a moisture content in equilibrium with air having a dew point of at most 25° C., thereby forming a dried granulate; —mixing the dried fiber material and the dried granulate to obtain the dry homogeneous mixture, whereby the volume percent of the fiber material is 10-80% of the dry homogeneous mixture.

If the fiber material and the thermoset particles are too large, they need to be reduced in size using known techniques. Depending on the raw materials, this reduction in size may occur before or after the drying step. Reduction in size and drying may also be done in several steps. If the fiber material and the thermoset particles contain too much moisture, they should be dried. In a first embodiment of the method according to the invention, the fiber material and the thermoset particles are dried separately. This offers the advantage that each drying equipment may be controlled at its own temperature and humidity, and that the driers may include other mechanical means for optimum drying of either the fiber material, or the granulate of thermoset particles. Drying before mixing also offers the advantage that the mixing of the fiber material and the granules in the desired ratio is better controllable with dry matter than with matter which contains too much moisture.

Preferably the drying of the fiber material is performed by bringing it in contact with dry warm air having a temperature of 100-300° C., preferably 150-300° C., more preferably 200-275° C., most preferably approximately 250° C., during for example a period of typically 1 to 3 hours, depending on the moisture content of the undried fiber material. Tests have shown that fibers such as e.g. glass or carbon fibers may be dried at a higher temperature than the granulate of thermoset particles. This offers the advantage of faster drying, or that a lower dew point may be reached within a given time.

Preferably, the drying of the granulate is performed by bringing it in contact with dry warm air having a temperature of 100-175° C., preferably a temperature of 125-160° C., more preferably a temperature of approximately 150° C.

In an alternative embodiment of the method according to the invention, providing the dry homogeneous mixture comprises the following steps:

providing a fiber material having an average length of 2-40 mm;

providing a granulate of thermoset particles having an average particle size of 2-15 mm;

mixing the fiber material and the granulate, whereby the volume percent of the fiber material is 10-80% of the mixture, and mixing the mixture into a homogeneous mixture;

drying the homogeneous mixture until the mixture has a moisture content which is in equilibrium with air having a dew point of at most 25° C., thereby forming the dry homogeneous mixture.

Thus, in an alternative embodiment, first the raw materials are mixed, and then the mixture is dried. This has the advantage that only one drying equipment is needed instead of two, and if desired, that the mixing may occur during the entire drying process, so that a separate step of mixing the dry fibers and the granular particles into a homogeneous mixture may be avoided.

Preferably the dry homogeneous mixture has a temperature of not more than 50° C., preferably not more than 45° C., more preferably not more than 40° C., even more preferably not more than 35° C. When the temperature of the dry homogeneous mixture is too high, the polyol and isocyanate will react faster, which is not desirable. On the other hand a temperature lower than the temperature of the environment is not desirable because it requires active cooling and/or slows down the reaction too much.

Preferably, the dry homogeneous mixture has a moisture content which is in equilibrium with air having a dew point of 5° C.-22° C., preferably from 10° C.-20° C., most preferably approximately 18° C. Tests have shown that the humidity of the dry homogeneous mixture is crucial for a proper adhesion of the fibers and the granular particles and for the mechanical properties of the shaped object, and that some moisture content is desired. If the moisture content is too low and thus the mixture too dry, then the polyol and the isocyanate will spread insufficiently throughout the mixture and lump formation will occur. If the humidity is too high and the mixture thus contains too much water, the mechanical properties of the shaped object are found not to be so good. Probably this is because the polyurethane will then react too quickly and/or show foam formation, and/or because a portion of the water will react with the isocyanate whereby CO₂ will be formed. The inventor has found that a method in which the humidity of the dry homogeneous mixture is reduced to a dew point of approximately 18° C. appears to give very good results.

Preferably the mixing of the viscous compound mixture is performed in a period of 10 seconds-10 minutes, preferably 10 seconds-5 minutes, more preferably 10 sec-2 minutes, even more preferably 10-60 seconds, most preferably substantially 20 seconds. Tests have shown that a good distribution of the polyol and the isocyanate in the dry homogeneous mixture is crucial for the mechanical properties of the end product. The longer the mixing time, the better the distribution, but this also depends strongly on the nature of the mixing machine. On the other hand, this time needs to be as short as possible, since the viscous homogeneous mixture needs to have been introduced into the mould, and the mould must have been brought under pressure before the reaction between the polyol and isocyanate begins. As known, this time may be “tailored” as desired, for example by adding known reaction rate reducers. Since information about this is freely available, no further explanation is required here. The time of mixing should be sufficiently large to get a good distribution, but preferably as short as possible to maximize the productivity. For a given dry homogeneous mixture and a given mixing machine, the optimal time may be determined by the person skilled in the art by performing a number of routine tests. If desired, the reaction may be extended by adding known reaction rate reducers.

Preferably, the average length of the fiber material is a length of 2-30 mm, preferably 3-20 mm, more preferably 4-15 mm, even more preferably 6-12 mm, most preferably approximately 8 mm. Tests have shown that not only the volume % of fibers, but also the average length of the fibers influences the mechanical properties (such as e.g. the flexural strength) of the shaped object, whereby a longer average length generally provides better mechanical properties (such as flexural strength). Typically good results are obtained for an average fiber length of at least 6 mm. A longer fiber length will somewhat improve the mechanical properties further, but usually the aesthetic appearance will somewhat decrease. The person skilled in the art may select an optimal average fiber length depending on the intended application.

Preferably the granules have an average particle diameter of 2-10 mm, preferably 3-7 mm, more preferably approximately 6 mm. A disadvantage of small particles (e.g. 2 mm) is that much material remains in the mixer (mixing machine), in which the polyol and isocyanate are added to and mixed with the dry homogeneous mixture, after the viscous homogeneous mixture is removed from the mixer. A disadvantage of too large particles is that the aesthetic appearance of the shaped object is not so nice and that the object ends up being less strong. Furthermore, tests have shown that the amount of polyol and isocyanate which is added to the dry homogeneous mixture needs to be adjusted to the average particle diameter of the granules. The smaller the average particle size of the granulate, the more polyol and isocyanate should be added to achieve a good adhesion.

Preferably the volume percent of the fiber material in the dry mixture is 20-60%, preferably 30-50%, more preferably approximately 40%. Tests have shown that the volume percent of the fiber material in the mixture has a strong influence on the strength of the shaped object. Generally one may say: the more fiber material, the stronger the end product (e.g. in terms of flexural strength), provided the amount of binder (i.e. polyol and isocyanate) is adjusted to the average length and quantity of the fibers and the average particle size of the granules.

Preferably the weight percent of the at least one polyol and the at least one isocyanate together is 5.0-20.0% of the dry mixture, preferably 5.0-15.0%, more preferably 5.5-10.0%, most preferably approximately 7.0%. Polyol and isocyanate together will form polyurethane which acts as a binder between the fibers and the granular particles of the shaped object. If an insufficient amount of binder is added to the dry homogeneous mixture, e.g. less than 5.0 weight percent, there will be an insufficient distribution of the polyol and the isocyanate, and then not all particles will be bound together, or only with a very thin film, which translates into reduced or even poor mechanical properties (such as flexural strength). If too much polyol and isocyanate is added, e.g. more than 15 weight percent, then the viscous compound mixture is very fluid, and the mixing device will be too wetted, which significantly increases the risk that the machine will stall. Moreover, these raw materials (polyol and isocyanate) are rather expensive, so that a moderate use thereof is recommended. Again, for a given dry mixture the optimum amount of binder may be determined by the skilled person, by carrying out routine tests, whereby a value of 7 weight percent is a good starting value.

Preferably the curing of the viscous homogeneous mixture occurs in the mould having a temperature of 15-50° C., preferably 15-40° C., more preferably 15-30° C., most preferably approximately 20° C. The mould is not heated, which is a major advantage of the method of the present invention, a.o. because of the energy savings. At the start of production the mould temperature is equal to the ambient temperature of the factory (e.g. 18° C. in winter time −30° C. in summer time), and the mould typically slightly warms up (e.g. +5 to 10° C.) during the production because of the compression and the exothermic reaction of the formation of polyurethane. A mould temperature of 20° C.-40° C. appears to give very good results, at temperatures above 50° C. the curing occurs somewhat too quickly, at temperatures below 15° C. too slowly.

Preferably the curing in the mould occurs at a pressure of at least 100 bar, preferably at least 150 bar, more preferably at least 175 bar, most preferably at least 200 bar. The pressure with which the viscous homogeneous mixture is compressed in the mould has an influence on the final volume of the object, but also on its mechanical properties. This pressure should be maintained during at least 1 minute, preferably during at least 2 minutes.

Preferably at least one kind of reject and/or recycled fiber material is used. And preferably at least one kind of reject or recycled thermoset particles is used. By using reject materials or used materials, such materials no longer have to be incinerated or landfilled, which is beneficial for the environment, but additionally these raw materials are available at a low price, allowing the cost of the shaped objects to be drastically reduced.

It is also an object of the invention to provide a shaped object produced by this method, in particular a drain cover which meets the requirements of load class B according to the standard NBN EN 124.

### BRIEF DESCRIPTION OF THE DRAWINGS

The present invention will be described in terms of particular embodiments and with reference to certain drawings but the invention is not limited thereto, but only by the claims. The drawings are only schematic and are not exhaustive. The drawings are not necessarily drawn to scale, and the size of some elements may be exaggerated for illustrative purposes. The dimensions and the relative dimensions do not necessarily reflect the actual proportions in the practice of the invention. The drawings are intended to describe principles of the invention. Embodiments of the invention may use combinations of the various features and elements of different drawings.

FIG. 1A shows an example of a method for providing a dry homogeneous mixture.

FIG. 1B shows schematically the steps of a preferred embodiment of the method according to the invention.

FIGS. 2A-2E show how a first shaped object, in particular a rectangular frame, may be formed in a first mould according to the method of the invention.

FIGS. 3A-3E show how a second shaped object, in particular a flat plate or a floor tile, may be formed in a second mould according to the method of the invention.

FIGS. 4A-4C show a drain cover according to the present invention, in perspective view, top view and side view.

FIGS. 5A-5C show a sewer pit according to the present invention, in perspective view, top view and side view.

FIG. 6 shows a clinker according to the present invention.

FIG. 7 shows a hydrant protection, or a hydrant base plate according to the present invention.

FIG. 8 shows a tile according to the present invention.

FIG. 9 shows a principle schematic of a mixer which may be used to perform the method of the present invention,

### DETAILED DESCRIPTION

### References

1 thermoset particles
2 granulate of thermoset particles having a predetermined average particle size.
3 dried granulate of thermoset particles
4 fiber material
5 fiber material having a predetermined average length
6 dried fiber material
7 polyol
8 isocyanate
10 dry mixture
11 dry homogeneous mixture
12 viscous mixture
13 viscous homogeneous mixture
14 homogeneous mixture
20 shaped object
21 drain cover
22 sewer pit, cleanout drain
23 clinker
24 base plate or frame for a hydrant
25 floor tile
28 mould
29 lower part of the mould
30 upper part of the mould
31 mixer, mixing device (of the viscous mixture)
32 motor
33 inlet1 for the dry homogenous mixture
34 inlet2 for polyol
35 inlet3 for isocyanate
36 outlet valve
37 shaft of the mixing device
38 mixing chamber
40 reducing the size of the granulate of thermoset particles
41 drying the granulate of thermoset particles
42 reducing the size of the fiber material
43 drying the fiber material
44 mixing the granulate and the fibers
45 drying the mixture
46 adding polyol
47 adding isocyanate
48 mixing the viscous mixture
49 curing of the viscous mixture in the mould
50 cooling of the granulate
51 cooling of the fiber material

The invention relates to a method for manufacturing a shaped object from a composite material which comprises thermoset particles, the method comprising the following steps:

a) providing a dry homogeneous mixture 11 comprising fiber material 4 with an average length of 2-40 mm and a granulate of thermoset particles with an average particle size of 2-15 mm, whereby the volume percent of the fiber material is 10-80% of the dry homogeneous mixture, and whereby the moisture content of the dry homogeneous mixture 11 is in equilibrium with air having a dew point of at most 25° C.;

b) adding at least one polyol 7 and at least one isocyanate 8 to the dry homogenous mixture 11 for forming a viscous mixture 12, whereby the weight percent of the at least one polyol 7 and the at least one isocyanate 8 together is 4.0-25.0% of the dry homogeneous mixture 11, and mixing the viscous mixture 12, thereby forming a viscous homogeneous mixture 13;

c) forming a shaped object 20 by curing the viscous homogeneous mixture 13 in a mould 28 at a temperature of 15-60° C. under a pressure p of at least 50 bar, whereby the pressure p is maintained for at least 1 minute.

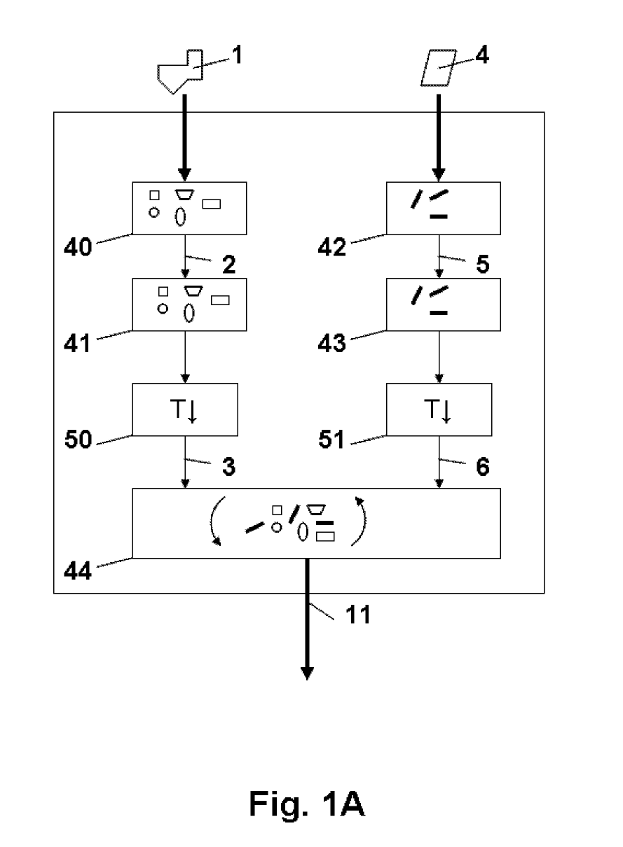

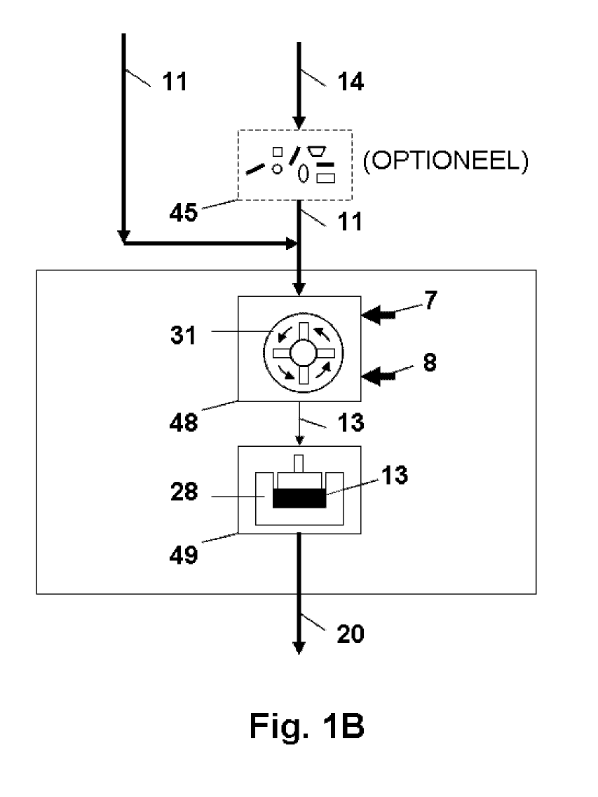

The steps of this procedure are illustrated in FIG. 1B, where a dry homogeneous mixture 11 is introduced into a mixing machine or mixer 31. An example of such a mixing machine 31 will be discussed in more detail further by means of FIG. 10. In the mixer 31 also an amount of polyol 7 and isocyanate 8 is introduced and distributed as uniformly as possible over the dry homogeneous mixture 11, so that a viscous homogeneous mixture 13 is obtained. Step 48 shows the mixing of the viscous mixture 13. This viscous homogeneous mixture 13 is introduced in a mould 28 which is for example located in a hydraulic press for exerting a pressure on the mould 28. After the viscous homogeneous mixture 13 in step 49 is at least partly cured in the mould 28, the shaped object 20 may be removed from the mould. Possibly conventional finishing treatments may be performed on the shaped object, such as deburring, grinding or drilling. The step 45 of drying the homogeneous mixture 14 (top of FIG. 1B) is an optional step. If the moisture content of the homogeneous mixture 14, which comprises fiber material and a granulate of thermoset particles, is sufficiently low (e.g. in equilibrium with air having a dew point of 18° C.) then the homogeneous mixture 14 does not need to be dried further, but may be introduced directly in the mixer 31. If the moisture content of the homogeneous mixture 14 is higher than a specified value (corresponding to a dew point of air of e.g. 18° C.), then the homogeneous mixture 14 is first dried in step 45 before being introduced into the mixing machine 31. The family of polyols and isocyanates for forming polyurethane are well known substances, which are freely available on the market, e.g. under the trade name Baydur20® offered by the company Bayer, but other polyols and isocyanates considered suitable by the skilled person may also be used.

FIG. 1A shows a preferred embodiment of a method for manufacturing the dry homogeneous mixture 11. Started is from a thermoset raw material 1, e.g. a granulate of recycled thermoset particles with dimensions of e.g. 5 mm-5 cm. This raw material is first reduced in size in step 40 by known techniques (e.g. grinding, cutting, etc) to an average particle diameter (also called “grain size”) of e.g. approximately 8 mm, and then dried in step 41. The size reduction step 40 may be skipped if the average particle diameter of the thermoset raw material 1 is already sufficiently small (e.g. <10 mm). The drying step 41 may be skipped if the moisture content of the thermoset raw material 1 is already sufficiently low (i.e. in equilibrium with air having a dew point of e.g. 18° C.). The moisture content of the granulate may be measured with known devices. If the granulate is dried, it must also be cooled (e.g. in contact with ambient air) to a temperature of e.g. at most 35° C. The result is a dried granulate 3 with an average particle size of e.g. 8 mm. One also starts from a fiber material 4, e.g. rolls of rejected glass fiber mats, which in step 42 are first reduced in size to fibers with an average length of e.g. approximately 6 mm, which in turn are dried in step 43. The step of reducing the fiber material size 42 may be skipped if the fiber material 4 is already sufficiently small. The step of drying the fiber material 43 may be skipped if the fiber material is already sufficiently dry. Like with the granules this moisture content may be measured. If the fiber material is dried, it also needs to cool down (e.g. in contact with ambient air) to a temperature of e.g. at most 35° C. The result is a dried fiber material 6 with an average length of e.g. 6 mm. The dried granulate 3 and the dried fiber material 6 are subsequently combined according to a ratio of e.g. 40 volume % of fibers, and mixed in step 44 into a dry homogeneous mixture 11. This mixing preferably occurs at room temperature (i.e. 18° C.-30° C.). Variations of the method for providing the dry homogeneous mixture 13 are possible. For example, depending on the characteristics (e.g. size) of the thermoset raw material 1, the granulate drying step 41 may be performed before step 40 for reducing the thermoset particle size. The same applies to the fiber material 4, where possibly the drying step 43 may be performed before the size reduction in step 42. Optionally, the mixing step 44 may also precede the step of cooling 50, 51. Or, as it often happens in practice, the cooling will partially occur before the mixing, and partially during or after the mixing. In a variant of the method for providing the dry homogeneous mixture 11, the size-reduced granulate may also first be mixed with the size-reduced fibers in the desired proportion (e.g. 40 volume % fibers), and then the mixture may be dried and cooled. Other variations to obtain a dry homogeneous mixture 11 may however also be used.

Referring back to FIG. 1B, when the dry homogeneous mixture 11 of FIG. 1A is almost immediately (e.g. within the hour when the air of the environment is not too humid) used in the mixer 31 of FIG. 1B, then the additional step 45 of drying the homogeneous mixture 14 is futile. However, if the dry homogeneous mixture 11 of FIG. 1A is first stored for several hours or even days in a non-hermetic packaging or container (e.g. in big bags of 1 m³) before being used in the mixer 31 of FIG. 1B, then the dry homogeneous mixture 11 will absorb moisture from the air and convert into a homogeneous mixture 14 which first needs to be dried in step 45 before being introduced into the mixer 31. As the moisture content of the dry homogeneous mixture 11 is important for the quality of the shaped object, in practice usually first the moisture content of the homogeneous mixture 14 is measured, and if it is higher than the predetermined value (e.g. in equilibrium with air having a dew point of 18° C.), then the homogeneous mixture 14 is dried in step 45 by bringing it in contact with dry warm air having a temperature of e.g. 50° C. and a dew point of e.g. 18° C. Preferably hereby a relatively low temperature of 50° C. is used to limit the warming-up of the homogeneous mixture 14. It is desirable to limit the temperature of the dry homogeneous mixture to about 35° C. or at most 40° C.

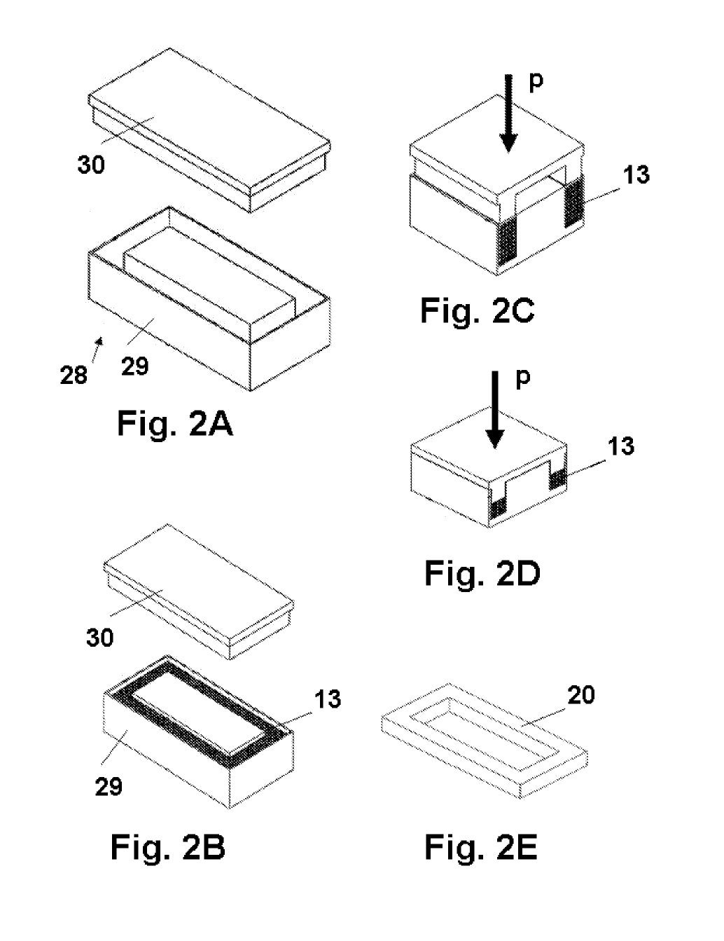

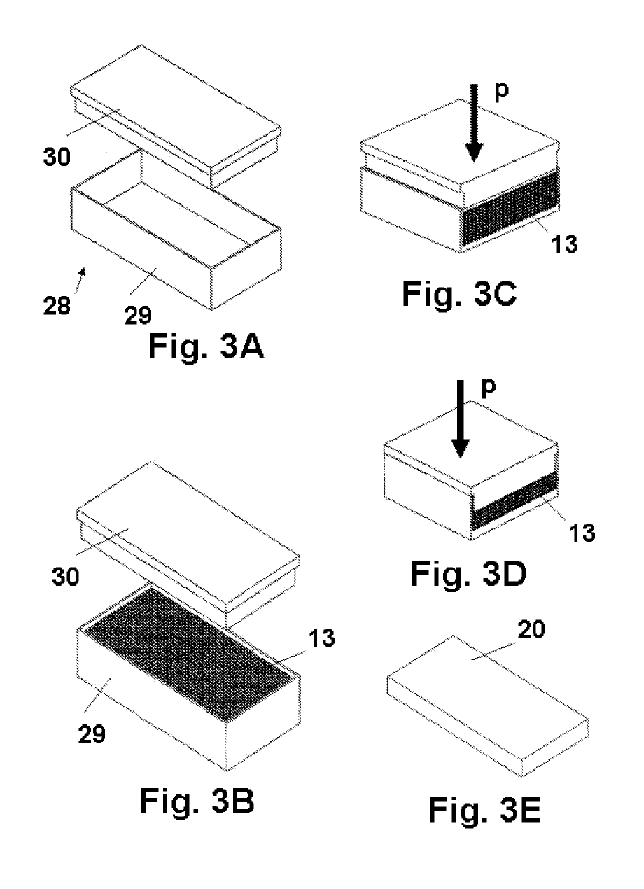

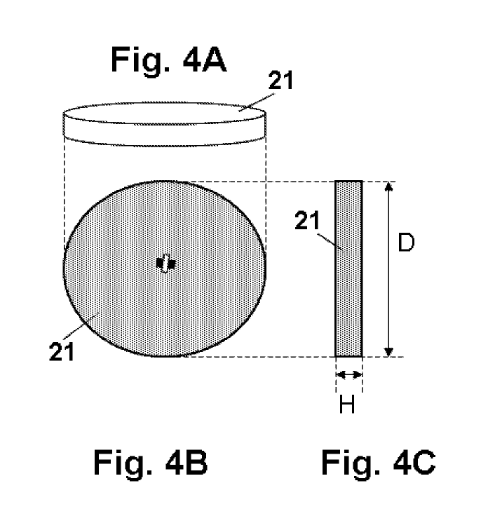

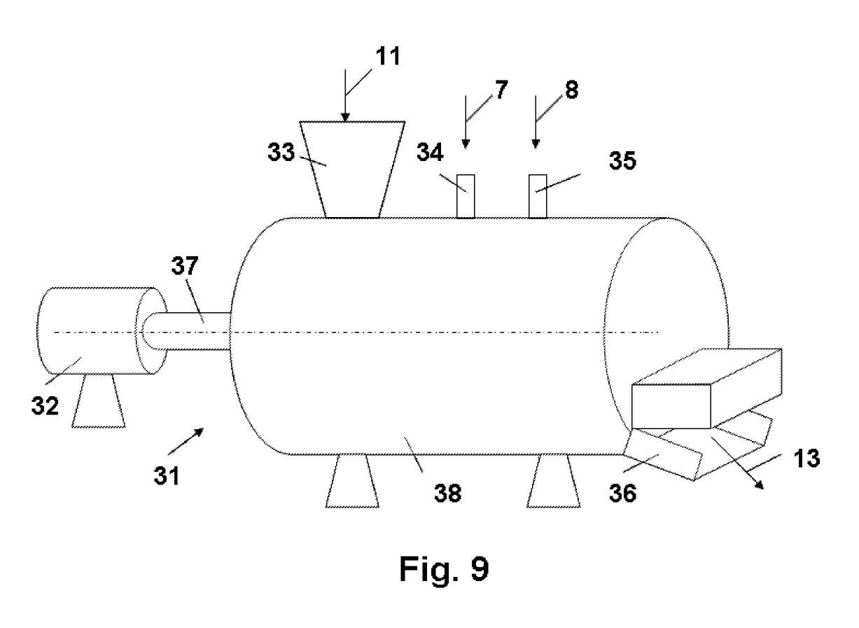

FIG. 9 shows schematically a preferred embodiment of a mixer 31 for adding at least one polyol 7 and at least one isocyanate 8 to the dry homogeneous mixture 11, and for distributing them as uniformly as possible, thereby forming a viscous homogeneous mixture 13. A motor 32 drives a shaft 37 which rotates inside a mixing chamber 38. On this shaft 37 is a spiral (not shown) resembling the screw of a typical injection moulding machine for moving the mixture in the mixing chamber 38 and to build up a pressure (of e.g. 2 bar). On this shaft 37 are also elements (not shown) for distributing the polyol 7 and the isocyanate 8 over the mixture. These elements may for example be flat or curved square or rectangular teeth (of e.g. 10 cm×10 cm×1 cm) attached to the shaft 37, and located at a distance (e.g. 10 cm) apart, and showing an angle (e.g. nearly 90°) relative to each other and having an angle to the shaft (e.g. alternating an angle of +45° and −45° for subsequent elements). But other mixers 31 suitable for distributing a liquid into a dry granulate may also be used. There are three inlets fitted to the mixer 31, more specifically to the mixing chamber 38: a first inlet 33 for introducing the dry homogeneous mixture 11, a second inlet 34 for adding at least one polyol 7, a third inlet 35 for adding at least one isocyanate 8. During operation of the mixer 31 first a quantity of the dry homogeneous mixture 11 will be introduced in the mixing chamber 38. This dry homogeneous mixture 11 is preferably at a temperature of at most 40° C., at most 35° C., preferably at ambient temperature (i.e. approximately 18° C. in winter time, to 30° C. in summer time). Temperatures above 30° C. may occur for example when a local drying step 45 of the homogeneous mixture 11 occurs as discussed in FIG. 1A and FIG. 1B. After introducing a quantity of the dry homogeneous mixture 11 in the mixing chamber 38 (e.g. approximately 8 kg, depending on the dimensions of the mixer), an amount of polyol 7 (e.g. approximately 280 g) and a quantity of isocyanate 8 (e.g. approximately 280 g), together being 7 percent by weight of the dry homogeneous mixture 11, are added, and distributed as uniformly as possible during a predetermined time (e.g. about 20-30 seconds) after adding the polyol 7 and the isocyanate 8, to form a viscous homogeneous mixture 13. The mixer 31 is preferably constructed such that after this predetermined time sufficient pressure is built up in the mixing chamber 38 so that the mechanical outlet valve 36 upon which a mechanical counter-pressure is exerted (e.g. by means of a spring) will open, so that the viscous homogeneous mixture 13 may leave the mixing chamber 38, and may be introduced into a mould 28. This is shown in FIG. 2A or 3A. The mould 28 is preferably made of steel, to be able to resist the high pressure of 100-200 bar. It was found that approximately 5 kg viscous homogeneous mixture remains in the mixing chamber 38 after opening of the outlet valve 36, in particular on the walls of the mixing chamber 38, on the spiral and the teeth, which would solidify onto the machine 31 if it would be shut down. To prevent that the mixing machine 31 will become blocked over time, the machine is so-called “dry flushed” before it is stopped. This may e.g. be done by filling the machine 31 again with the dry homogeneous mixture 11, but without the addition of polyol 7 and isocyanate 8. Because polyurethane is a thermoset material, this material may be recycled again. Flushing with another dry mixture (e.g. dried granules of thermoset particles without fibers) is also possible.

FIG. 2A shows an example of a mould 28 for producing a rectangular frame (see FIG. 2E), but other shapes considered suitable by the skilled person may also be used. As the mould 28 is not actively heated or cooled, the temperature of the mould 28 is approximately equal to the temperature of the environment (e.g. 18° C. in winter time −30° C. in summer time), although the mould 28 will slightly warm-up during production (e.g. +5 to 10° C.) because of compressing the viscous homogeneous mixture 13 and due to the exothermic reaction of the polyol 7 and the isocyanate 8. The mould 28 shown in FIG. 2A consists of two parts, a lower part 29 with a cavity in which the viscous homogeneous mixture 13 is introduced (FIG. 2B), and an upper part 30 which is moved towards the lower part 29, whereafter the two parts 29, 30 are being pressed together (FIG. 2C and FIG. 2D) under a predetermined pressure p, e.g. in a conventional press. To obtain a shaped object 20 with desired mechanical properties (e.g. hardness, flexural strength, tensile strength, porosity) this pressure p is a pressure of at least 50 bar, preferably at least 100 bar, more preferably at least 150 bar, even more preferably at least 175 bar, most preferably at least 200 bar. This pressure p may be maintained during the entire curing period (e.g. 4-8 minutes) or during only a portion thereof (e.g. 2 minutes), but other curing periods are also possible, e.g. 1 minute or 30 seconds. After curing, the mould 28 is opened, and the shaped object 20 is removed from the mould. FIG. 2E shows an example of a thus formed rectangular frame, which may e.g. be used as base plate (foundation pad) for a fire hydrant. Typical dimensions are: 11 cm high, 70 cm long, 50 cm wide, 8 cm wall thickness.

FIGS. 3A-3E show a second example of a mould 28 with another cavity, and a second shaped object 20, in this case a floor tile or a paving tile or a cover or a flat plate with predetermined dimensions (length, width and thickness). The mechanical properties of this cover 20 are both determined by the raw materials used:

the choice of the fiber material, e.g. glass fiber, carbon fiber or fibers of thermoset materials, whereby carbon fibers usually provide a greater strength than e.g. glass fibers;

the average length of the fibers, e.g. 8 mm;

the choice of the granulate of thermoset particles, which is e.g. derived from recycled polyurethane or recycled bakelite or other thermoset materials;

the average particle size (also called “grain size”) of the granulate, e.g. 6 mm;

the volume percent of the dry fiber material and the dry granulate, e.g. a ratio 20/80 or 30/70 or 40/60 or 50/50;

the amount of polyol 7 and the amount of isocyanate 8 added to the dry homogeneous mixture 11, e.g. approximately 290 g isocyanate and approximately 270 g polyol which are added to approximately 8 kg of dry mixture;

and also by the process parameters:

the temperature, moisture content and uniformity of the dry homogeneous mixture 11, the time during which the viscous mixture is being mixed in the mixer 31, the temperature, moisture content and uniformity of the viscous mixture 13, the temperature of the mould 28, the pressure p exerted upon the mould 28 during curing, the time during which the pressure p is applied (e.g. 2 minutes),

and by external factors, such as temperature and humidity of the environment, although these are as far as possible excluded.

The skilled person may measure the mechanical properties of a shaped object 20 thus produced, and may adjust the choice of the materials and/or the mixing ratio and/or the process parameters, if required. The inventor has found that metal fibers or metal chips also work well as filler material and show good adhesion to the binder (polyurethane), but he has also found that they lead to rust and form sharp protrusions on the surface of the shaped product 20, which is undesirable. Incorporating e.g. an aluminum handle or an aluminum plate with an inscription (e.g. coordinates) on the other hand is very interesting.

FIGS. 4A-4C show respectively. in perspective view, top view and side view an example of a drain cover 21 (also called “cover for a drain inspection point”) which may be produced according to the method described above. This drain cover 21 has a thickness of e.g. 50 mm and a diameter of e.g. 160, 250, 315, 400 or 630 mm, but drain covers 21 with other dimensions may also be produced. Such drain covers 21 are today usually made of concrete or steel or cast iron, and the mechanical requirements which they have to meet are specified in the standard NBN EN 124. In summary, it means that there are three load classes' defined for drain covers, load class A (15 kN) for traffic zones which may only be used by pedestrians or cyclists, load class B (125 kN) for sidewalks, parking lots or parking floors for cars, and load class C (250 kN) for zones between roadway and sidewalk, and parking spaces accessible to heavy traffic. The test consists in that using a given force (15 kN, 125 kN, 250 kN) a stamp having a diameter of 25 cm is pressed on the drain cover 21, whereby certain criteria must be met with respect to static load, dynamic load, and breaking load, as described in the standard NBN EN 124. A drain cover 21 which meets load class B also meets load class A. A drain cover 21 which meets load class C also meets load classes A and B.

The inventor has experimentally found that a drain cover 21 of 50 mm thick and e.g. 315 mm in diameter which meets load class B according to standard NBN EN 124, and a drain cover 21 of 60 mm thick and e.g. 315 mm in diameter which meets load class C according to standard NBN EN 124 may be manufactured by a method as described above, in which:

the fibrous material mainly comprises recycled glass fibers;

the fiber material is reduced in size until the average length of the fiber material is approximately 6 mm;

drying of the fiber material is performed by bringing it in contact with hot dry air having a temperature of 250° C., and drying the air until the air reaches a dew point of at most 5° C. (This may e.g. be performed in a known dry air supply system such as commercially available from Mann+Hummel under the brandname Somos®);

the granulate of thermoset particles mainly comprises recycled polyurethane particles;

the granules are reduced in size until the average particle diameter of the granules is approximately 6 mm;

drying the granulate of the thermoset particles is performed by bringing it in contact with dry hot air having a temperature of 150° C., and drying the air in a second dry air supply system, until this air has reached a dew point of at most 18° C.;

the volume percent of the fiber material in the dry homogeneous mixture 11 is approximately 40%, and the volume percentage of the granules in the dry homogeneous mixture 11 is approximately 60%;

this dry homogeneous mixture 11 is possibly stored a few hours or days in bags (or containers or “big bags”), exposed to the ambient air until it may be processed in the mixer 31;

drying the homogeneous mixture 11 again just before processing in the mixer 31, by bringing it in contact with dry warm air of 50° C. in a third dry air supply system until the air has reached a dew point of at most 18° C.;

the weight percentage of the polyol 7 and the isocyanate 8 which is added to the dry homogeneous mixture 11 under ambient temperature (typically 18° C. in winter −30° C. in summer) together is approximately 7 weight percent of the dry homogeneous mixture 11;

the quantity of the viscous homogeneous mixture 13 which is introduced into the mould 28 is approximately 2.0 times the volume of the open space in the mould 28;

the curing occurs in a mould 28 which has a temperature of approximately 18° C.-30° C., whereby the curing takes place under a pressure of approximately 200 bar, whereby the pressure is maintained during a period of approximately four minutes.

Comparative tests for making such drain covers, whereby the same amount of viscous homogeneous mixture 13 was introduced into the mould 28, but whereby the pressure p was maintained for only 2 minutes instead of 4 minutes, showed that the thickness of the drain cover was approximately 5.2-5.3 cm instead of 5.0 cm. Although the mechanical properties of this cover were not precisely determined, it is expected that it was at least 10% less strong (e.g. in terms of deflection).

The factor of approximately 2.0 volume compression was observed in manufacturing drain covers with a thickness of 5 cm and a diameter of 25 cm, 30 cm and 40 cm. (other diameters were not tested).

Drop tests whereby this drain cover 21 was dropped from a height of 3 and 7 meters on a hard surface (clinkers) without breaking, show that this drain cover 21 has a high impact resistance. Concrete drain covers are much more fragile. Temperature tests have shown that the drain covers 21 according to the invention are suitable for use in a temperature range of −40° C. to +70° C. and that the thermal expansion is negligibly small.

The inventor has also surprisingly found that the material of this drain cover 21 attaches very well to cement or concrete. Other advantages of this drain cover are that it is easy to drill, cut, mill, saw, etc. into this material, which is not possible or much more difficult with a cast iron cover. Moreover, the surface of the cover also turns out to show very good anti-slip properties, so that the traditional protruding small blocks present on classical cast iron drain covers to increase the grip of shoes or tires during winter, may be omitted. These blocks are very inconvenient for pedestrians and cyclists. Finally, the weight of the drain cover 21 according to the invention (typically 4 kg) is much lighter than a comparable cast iron drain cover (typically 8 kg), making it easier to open or install. Moreover, it does not rust, but retains its aesthetical appearance. Furthermore, it can not become stuck by rusting, which is a major advantage compared to cast iron drain covers, where one is often faced with this problem.

These improved mechanical properties will naturally also apply to other shaped objects 20 produced by this method and with the same composition, regardless of the specific shape.

Trials where the same viscous homogeneous mixture 13 was used for the manufacture of a foundation pad for a hydrant 24 (as shown in FIG. 3E or FIG. 8) whereby a pressure of 130 bar was used, and whereby the pressure was maintained for only 2 minutes, showed that the quantity of the viscous homogeneous mixture 13 to be introduced in the mould 28 is only approximately 1.5 times the volume of the space in the mould 28.

To produce drain covers 21 which satisfy load class A of the standard NBN EN 124 probably a pressure of 100 bar is already sufficient, and/or the volume % of fiber material may probably be reduced, and/or a smaller average fiber length may be sufficient. The skilled person may readily determine the influence of each of the above mentioned parameters, or one or several combinations thereof, on the flexural strength of the drain cover 21 by performing routine tests.

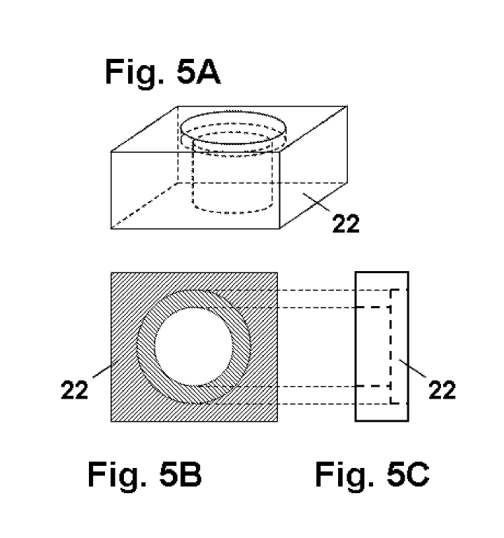

FIGS. 5A-5C show respectively in perspective view, top view and side view an example of a sewer pit 22 which may be manufactured according to the method as described above. Typical outer dimensions are e.g. 40 cm×40 cm×20 cm, but the invention is not limited thereto, and sewer pits 22 with other dimensions or shapes are also possible.

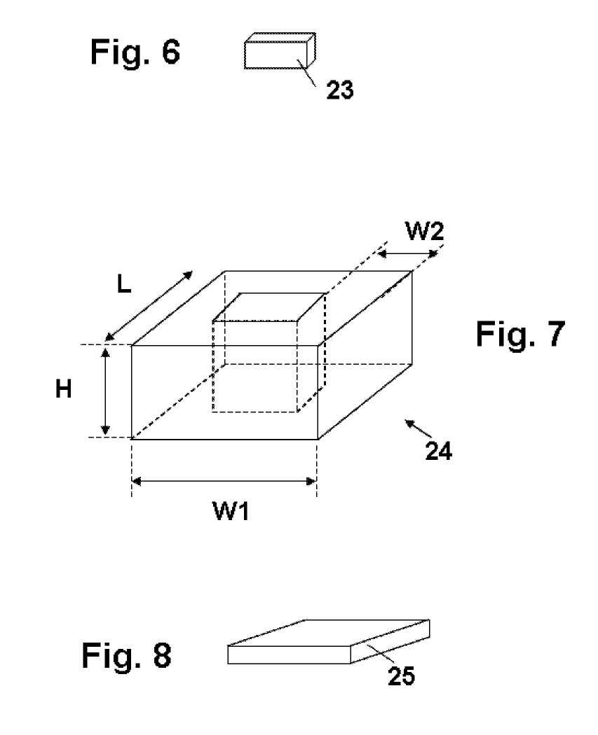

FIGS. 6 to 9 show examples of other typical shaped objects 20 which may be produced according to the method of the present invention, but the invention is not limited thereto, and other shapes are also possible, such as planters, garden pots or other garden objects, but also other objects are possible.

FIG. 6 shows a clinker 23 as may be used on a driveway or parking lot. Typical dimensions of such a clinker are 10 cm×10 cm×20 cm. The low weight, the ability for mechanical machining (cutting, sawing, milling, drilling, etc.), the frost-resistance, the anti-slip and the shock resistance are highly desirable properties of this product for this application. Moreover, its cost will be very low when for at least part of the raw materials reject or recycled materials are used.

FIG. 8 shows a hollow tube 24 which may be used as a frame for a fire hydrant. Typical dimensions for this tube 24 are: W1=60 cm, H=20 cm, L=40 cm, W2=4 cm. The weight of a tube according to the invention is approximately 24 kg. Such tubes offer e.g. protection to fire hydrants against damage induced by e.g. flail mowers, when they are cutting the crop along the side of the street, and accidentally collide against such tube 24. The impact resistance of the material of the tube 24 as obtained by the method of the invention is particularly suitable to absorb shocks of such flail mowers.

FIG. 9 shows a floor tile or paving tile 25. Typical dimensions are e.g. 20 cm×20 cm×4 cm thick, or 30 cm×30 cm×4 cm thick. The same favorable properties as for the clinker are also applicable here.

But the invention is not limited to the shapes shown in the figures. For example, the method may also used for manufacturing round frames, flat rectangular or round panels, round or rectangular lids, hollow cylindrical or bar-shaped pits, etc.

Preferably, at least one kind of recycled fiber material and/or at least one kind of recycled thermoset particles are used.

Preferably, the recycled thermoset particles are at least partly derived from one or more kayaks, one or more plastic windows, billiard balls, or combinations thereof. But the invention is not limited thereto, and other thermoset materials may also be used.

In an embodiment the volumetric quantity of the viscous homogeneous mixture 13 which is introduced into the mould 28 is 1.3-2.3 times the volume of the shaped object 20, preferably 1.8-2.2 times the volume of the shaped object 20.

Preferably, the recycled fiber material is at least partly derived from the group of used or reject glass fibers, glass fiber mats, belts, shoes, or combinations thereof. For example also leather items can be used.

In one embodiment, the object is a grating, particularly an animal house grating. For this purpose the following features are especially advantageous: the material is not affected by urine (as opposed to steel or cast iron), the material is a good thermal insulator (so that the use of straw as bedding may be avoided), the anti-slip so that an animal will not so readily stumble and injure itself.

If desired or necessary, the skilled person may add other substances into the dry mixture or viscous mixture 12, such as for example pigments or reaction rate reducers, UV stabilizer, flame retardant, dye or the like.

Although the present invention is described in terms of specific embodiments, it will be evident that various modifications may be made to these embodiments without deviating from the broader scope of the invention as set out in the claims. Consequently, the description and drawings are to be considered in an illustrative sense rather than a restrictive sense.

1.-23. (canceled)

24. A method for manufacturing a shaped object from a composite material which comprises thermoset particles, wherein the method comprises the following steps:
a) providing a dry homogeneous mixture comprising fiber material with an average length of 2-40 mm and a granulate of thermoset particles with an average particle size of 2-15 mm, whereby the volume percent of the fiber material is 10-80% of the thy homogeneous mixture, and whereby the dry homogeneous mixture has a moisture content which is in equilibrium with air having a dew point of at most 25° C.;
b) adding at least one polyol and at least one isocyanate to the dry homogenous mixture for forming a viscous mixture, whereby the weight percent of the at least one polyol and the at least one isocyanate together is 4.0-25.0% of the dry homogeneous mixture, and mixing the viscous compound mixture, thereby forming a viscous homogeneous mixture;
c) forming a shaped object by curing the viscous homogeneous mixture in a mould at a temperature of 15-60° C. and under a pressure (p) of at least 50 bar, whereby the pressure (p) is maintained during at least 1 minute.

25. The method according to claim 24, wherein the step of providing the dry homogeneous mixture comprises the following steps:
providing a fiber material with an average length of 2-40 mm, and drying the fiber material until the fiber material has a moisture content which is in equilibrium with air having a dew point of at most 25° C., thereby forming a dried fiber material;
providing a granulate of thermoset particles with an average particle size of 2-15 mm, and drying of the granulate until the granulate has a moisture content which is in equilibrium with air having a dew point of at most 25° C., thereby forming a dried granulate;
mixing the dried fiber material and the dried granulate to obtain the dry homogeneous mixture, whereby the volume percent of the dried fiber material is 10-80% of the dry homogeneous mixture.

26. The method according to claim 25, wherein the step of drying the fiber material is performed by bringing the fiber material in contact with warm air having a temperature of 100-300° C.

27. The method according to claim 25, wherein the step of drying the granulate is performed by bringing the granulate in contact with warm air having a temperature of 100-175° C.

28. The method according to claim 24, wherein the step of providing the dry homogeneous mixture comprises the following steps:
providing a fiber material having an average length of 2-40 mm;
providing a granulate of thermoset particles having an average particle size of 2-15 mm;
mixing the fiber material and the granulate, whereby the volume percent of the fiber material is 10-80% of the mixture, and mixing the mixture into a homogeneous mixture;
drying the homogeneous mixture until the mixture has a moisture content which is in equilibrium with air having a dew point of at most 25° C., thereby forming the dry homogeneous mixture.

29. The method according to claim 24, wherein the dry homogeneous mixture has a temperature of at most 50° C.

30. The method according to claim 24, wherein the dry homogeneous mixture has a moisture content which is in equilibrium with air having a dew point of 5° C.-22° C.

31. The method according to claim 24, wherein the mixing of the viscous mixture is performed in a period of 10 seconds-10 minutes.

32. The method according to claim 24, wherein the average length of the fiber material is in the range of 2-30 mm.

33. The method according to claim 24, wherein the granulate has an average particle diameter in the range of 2-10 mm.

34. The method according to claim 24, wherein the volume percent of the fiber material in the dry mixture is 20-60%.

35. The method according to claim 24, wherein the weight percent of the at least one polyol and the at least one isocyanate together is 5.0-20.0% of the dry homogenous mixture.

36. The method according to claim 24, wherein the curing occurs in the mould at a temperature of 15-50° C.

37. The method according to claim 24, wherein the curing in the mould occurs at a pressure (p) of at least 100 bar.

38. The method according to claim 24, wherein the fiber material comprises fibers selected from the group consisting of glass fibers, carbon fibers, fibers of thermoset materials, and mixtures thereof.

39. The method according to claim 24, wherein the granulate of thermoset particles comprises at least one element selected from bakelite particles and polyester particles and polyurethane particles and cellulose particles, and mixtures thereof.

40. The method according to claim 24, wherein the fiber material is at least one kind of recycled fiber material.

41. The method according to claim 40, wherein the thermoset particles are at least one kind of recycled thermoset particles.

42. The method according to claim 41, whereby the recycled thermoset particles are at least partly derived from at least one element selected from kayaks, one or more plastic windows, billiard balls, and combinations thereof.

43. The method according to claim 40, wherein the recycled fiber material is at least partly derived from the group consisting of used and reject glass fibers, fiber glass mats, belts, shoes, and combinations thereof.

44. The method according to claim 24, wherein the volumetric quantity of the viscous homogeneous mixture which is introduced into the mould is 1.3-2.3 times the volume of the shaped object.

45. The method according to claim 24 for producing a composite drain cover which meets the requirements of load class A and/or B and/or C according to standard NBN EN 124.

46. The method according to claim 45, whereby:
the fiber material comprises recycled glass fibers;
the average length of the dried fiber material is 4-10 mm;
the granulate of thermoset particles comprises recycled polyurethane;
the average particle diameter of the dried granulate is 4-8 mm;
the volume percent of the dried fiber material in the dry homogeneous mixture is 30%-60%;
the weight percent of the polyol and the isocyanate which is added to the dry homogeneous mixture together is 5-10% of the thy homogeneous mixture;
the dry homogeneous mixture has a moisture content which is in equilibrium with air having a dew point of 10-20° C.;
the quantity of the viscous mixture which is introduced in the mould is 1.8-2.2 times the volume of the space in the mould;
the curing takes place in a mould at a temperature of 18-35° C. which is subjected to a pressure of at least 50 bar, during a period of at least 2 minutes.

47. A shaped object, produced by the method according to claim 24.

48. The object according to claim 47, selected from the group consisting of a drain cover, a drain cover which meets the requirements of load class A and/or load class B and/or load class C according to the standard NBN EN 124, a grating, an animal house grating, a clincker, a floor tile, a roof tile, a base plate for a fire hydrant and a frame for a fire hydrant.
